(19) United States
(12) Patent Application Publication
(10) Pub. No.: US 2012/0169129 A1
(43) Pub. Date: Jul. 5, 2012

(54) Energy Storage Device

(75) Inventors: Jun-Sik Kim, Yongin-si (KR); Chong-Hoon Lee, Yongin-si (KR); Sung-Soo Kim, Yongin-si (KR); Seol-Ah Lee, Yongin-si (KR); Seok-Gyun Woo, Yongin-si (KR); So-Ra Lee, Yongin-si (KR); Jake Kim, Yongin-si (KR); Min-Hwan Kim, Yongin-si (KR); Do-Hyung Park, Yongin-si (KR); Jong-Ki Lee, Yongin-si (KR); Yoon-Chang Kim, Yongin-si (KR)

(73) Assignee: SAMSUNG SDI CO., LTD., Yongin-si (KR)

(21) Appl. No.: 13/209,609

(22) Filed: Aug. 15, 2011

(30) Foreign Application Priority Data
Jan. 5, 2011 (KR) 10-2011-0001135

(51) Int. Cl. H02J 7/34; H01M 16/00

(52) U.S. Cl. 307/80; 429/9

(57) ABSTRACT

An energy storage device formed by a combination of aqueous battery unit cells and non-aqueous battery unit cells is provided. The energy storage device comprises a first energy storage module formed by connecting at least one of aqueous battery unit cells in series and a second energy storage module formed by connecting at least one of lithium ion battery unit cells in series, wherein the first energy storage module and the second energy storage module are connected in parallel, the lithium ion battery unit cell is formed of a cathode active material such as LiFePO₄ (LFP) or LiMn₂O₄ (LMO), and a voltage of the second energy storage module is included within a predetermined margin of error with reference to a voltage of the first energy storage module.

### CLAIM OF PRIORITY

This application makes reference to, incorporates the same herein, and claims all benefits accruing under 35 U.S.C. §119 from an application earlier filed in the Korean Intellectual Property Office on 5 Jan. 2011 and there duly assigned Serial No. 10-2011-0001135.

### BACKGROUND OF THE INVENTION

1. Field of the Invention

The present invention relates to an energy storage device having large capacity and formed of a combination of aqueous and non-aqueous rechargeable batteries.

2. Description of the Related Art

A commonly used energy source is an energy source based on fossil fuels, such as coal and petroleum; and abuse of fossil fuels causes environmental problems such as air pollution and the like.

In order to solve such problems of fossil fuels, electric energy replaces the fossil fuel as clean energy, but an energy source shortage problem should be solved and electric energy generation/distribution efficiency should be increased. Further, methods for increasing energy efficiency in energy storage using a rechargeable battery should be studied.

In modern society, electric energy has various usages, and particularly, a technology using a rechargeable battery that can be charged and discharged for power source of vehicles or industrial purpose has been under the spotlight. Thus, development for an electric vehicle (EV) driven using only a battery and a hybrid electric vehicle (HEV) driven using a battery and an existing fuel powered engine has been accelerated.

In order to be used as a battery source for the electric vehicle or the hybrid electric vehicle, high power and large capacity are required so that a battery pack is formed by connecting small-sized rechargeable battery cells.

A rechargeable battery used for starting a vehicle engine, or for an industrial purpose, is an aqueous rechargeable battery, and a lead-acid battery or a nickel-metal hydride (NiMH) battery is commonly used as the aqueous rechargeable battery.

The lead-acid battery has problems in density, output, and life-span characteristic although it is inexpensive, and thus the NiMH battery is used as the aqueous rechargeable battery for a portable device and the hybrid electric vehicle requiring high energy density and output.

In addition, use of a lithium ion battery as a non-aqueous rechargeable battery has been attempted. The lithium ion rechargeable battery has merits of high energy density and output and excellent life-span so that it becomes more widely applied to a small-sized mobile device and a middle and large-sized battery for industry and vehicle (HEV and EV).

However, for common use as a power source for the electric vehicle or the hybrid electric vehicle, the lithium ion battery should be used as a rechargeable battery having high power and large capacity, but the lithium ion rechargeable battery is relatively expensive per capacity and safety cannot be sufficiently guaranteed, so use as a large-sized battery is delayed even though it has an excellent battery characteristic.

Thus, an energy storage system with an inexpensive battery having high output and large capacity should be studied to replace an existing market.

The charge and discharge current of a battery is measured in C-rate. Most portable batteries are rated at 1 C. This means that a 1000 mAh battery would provide 1000 mA for one hour if discharged at 1 C rate. The same battery discharged at 0.5 C would provide 500 mA for two hours. At 2 C, the 1000 mAh battery would deliver 2000 mA for 30 minutes. 1 C is often referred to as a one-hour discharge; a 0.5 C would be a two-hour, and a 0.1 C a 10-hour discharge.

The capacity of a battery is commonly measured with a battery analyzer. If the analyzer's capacity readout is displayed in percentage of the nominal rating, 100% is shown if a 1000 mAh battery can provide this current for one hour. If the battery only lasts for 30 minutes before cut-off, 50% is indicated.

The above information disclosed in this Background section is only for enhancement of understanding of the background of the invention and therefore it may contain information that does not form the prior art that is already known in this country to a person of ordinary skill in the art.

### SUMMARY OF THE INVENTION

Aspects of embodiments of the present invention relates to an energy storage device that can be used as an inexpensive middle and large-sized battery for industry and vehicle power so as to be applied to an existing market.

A large-sized battery according to aspects of embodiments of the present invention has excellent energy density, output, and life-span by combining battery characteristics of an aqueous rechargeable battery and a non-aqueous rechargeable battery. The technical problems achieved by the present invention are not limited to the foregoing technical problems. Other technical problems, which are not described, can clearly be understood by those skilled in the art from the following description of the present invention.

An energy storage device according to embodiments of the present invention comprises a first energy storage module formed by connecting at least one of aqueous battery unit cells and a second energy storage module formed by connecting at least one of non-aqueous lithium ion battery unit cells, and the first and second energy storage modules are connected in parallel.

The first energy storage module is configured to connect to a plurality of unit cells of an aqueous battery such as a lead-acid battery or a nickel-metal hydride battery in series.

The second energy storage module is configured to connect to a plurality of unit cells of a non-aqueous battery such as a lithium ion battery.

A cathode active material for the lithium ion battery unit cell is LiFePO₄ (lithium iron phosphate, also known as LFP) or LiMn₂O₄ (Lithium-manganese oxide, also known as LMO).

The second energy storage module formed of the lithium ion battery unit cell has a voltage that corresponds to a voltage of the first energy storage module formed of the unit cell of the aqueous battery such as the lead-acid battery of the nickel-metal hydride battery. The voltage of the second energy storage module may be set to be included within a predetermined margin of error with the voltage of the first energy storage module. In this case, the margin of error may be 80% to 120% of the voltage of the first energy storage module. For example, the voltage of the first energy storage module may be 12V, and the voltage of the second energy storage module may be 9.6V to 14.4V by connecting a plurality of lithium ion battery unit cells in series.

The second energy storage module may be formed of a lithium ion battery unit cell having a voltage that is lower or higher than the voltage of the aqueous battery unit cell.

As an exemplary embodiment, a negative active material for the lithium ion battery unit cell may be graphite or Li₄Ti₅O₁₂ (lithium titanate spinel oxide, also known as LTO).

A voltage of the aqueous battery unit cell may be 1.0V to 2.5V and a voltage of the lithium ion battery unit cell may be 1.5V to 3.5V.

In this case, the aqueous battery unit cell may be a lead-acid battery and the lithium ion battery unit cell may be LiFePO₄/Li₄Ti₅O₁₂ (LFP/LTO), but they are not limited thereto.

In the energy storage device according to embodiments of the present invention, the storage capacity of the first energy storage module may be 50% or more to 100% or less of a total storage capacity of the energy storage device in consideration of energy density, energy output, and life-span, but it is not limited thereto.

The storage capacity of the second energy storage module may be 10% to 50% of the total storage capacity of the energy storage device.

The energy storage device according to embodiments of the present invention may further comprise a switching unit including at least one switch connected to the first energy storage module or the second energy storage module and a controller generating a selection signal for controlling switching operation of the switch and selecting the first energy storage module or the second energy storage module.

A cathode active material and a negative active material of the lithium ion battery unit cell may have nano miter-sized primary particles.

The diameter of the primary particle is preferably 10 nm to 2000 nm, but it is not limited thereto. The diameter of the primary particle may be 500 nm.

A combination of the aqueous battery unit cell-lithium ion battery unit cell of the energy storage device according to the exemplary embodiment of the present invention may be selected from combinations of Pb-acid-LFP/LTO, Pb-acid-LMO/LTO, Pb-acid-LFP/Graphite, Pb-acid-LMO/Graphite, and NiMH-LMO/LTO.

An energy storage device according to embodiments of the present invention can be supplied with low cost for the purpose of a middle and large-sized battery for industry and vehicle. Particularly, an electric energy storage device of a stable dual system (parallel system) having excellent energy density and output and long life-span can be provided by supplementing drawbacks of the aqueous battery and the non-aqueous battery.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a schematic diagram of an energy storage device according to an exemplary embodiment of the present invention;

FIG. 2 is an EMP photo of an active material of a lithium ion battery unit cell according to the exemplary embodiment of the present invention;

FIG. 3 and FIG. 4 are graphs of capacity characteristics according to increase of C-rate in the energy storage device according to the exemplary embodiment of the present invention;

FIG. 5 is a graph of a characteristic of life-span changed according to a structure of an aqueous battery unit cell and a lithium ion battery unit cell in the energy storage device according to the exemplary embodiment of the present invention; and

FIG. 6 is a graph illustrating a charging/discharging curve line in the case of forming a system through connection to the energy storage device according to the exemplary embodiment of the present invention in series.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

Further, in the exemplary embodiments, like reference numerals designate like elements throughout the specification representatively in a first exemplary embodiment and only elements other than those of the first exemplary embodiment will be described.

The drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising”, will be understood to imply the inclusion of stated elements but not the exclusion of any other elements.

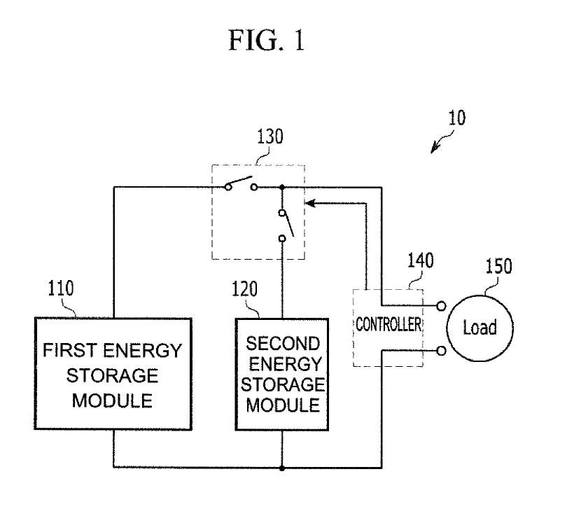

FIG. 1 is a schematic diagram of an energy storage device 10 according to an exemplary embodiment of the present invention.

The energy storage device 10 of FIG. 1 includes a first energy storage module 110 formed of a plurality of aqueous batteries, a second energy storage module 120 formed of a plurality of non-aqueous batteries, a switching unit 130 including switches respectively connected to the first energy storage module 110 and the second energy storage module 120, and a controller 140 generating and transmitting a selection signal controlling the switching unit 130 and controlling charging/discharging of the first and second energy storage modules 110 and 120.

The energy storage device 10 of FIG. 1 is formed of a dual compound of storage modules respectively formed of the aqueous battery unit cells and the non-aqueous battery unit cells. Here, the unit cell implies a single battery. A load 150 is connected to the energy storage device 10 and consumes the energy stored therein.

The first energy storage module 110 includes a plurality of aqueous battery unit cells. The unit cells of the plurality of aqueous batteries are not particularly restrictive, and they may be the same or different in type.

Preferably, the unit cell of the aqueous battery may be a unit cell of a lead-acid (Pb-acid) battery or a unit cell of a nickel-metal hydride battery (NiMH) battery. A voltage of the unit cell of the Pb-acid battery is about 2V, and a voltage of the unit cell of the nickel-metal hydride battery is about 1.2V. Here, the unit cell voltage implies a middle voltage value between the maximum charging voltage and the maximum discharging voltage of the corresponding battery unit cell.

In the present invention, the second energy storage module 120 is formed to control a voltage within a predetermined margin of error with a module formed by connecting non-aqueous battery unit cells in series. The margin of error may correspond to a voltage range of 80% to 120% of the voltage of the first energy storage module 110, but it is not limited thereto. When the voltage of the first energy storage module 110 is 12V, the voltage of the second energy storage module 120 may be set to 9.6V to 14.4V by controlling a combination of lithium ion battery unit cells.

The capacity of the first energy storage unit 110 formed of unit cells of the Pb-acid battery or the NiMH battery may be higher than 50% to lower than 100% of the capacity of the energy storage device 10, and preferably may be about 50% of the capacity of the energy storage device 10. The capacity of the first energy storage module 110 is set to about 50% of the capacity of the entire energy storage capacity and the second energy storage module 120 is connected in parallel with the first energy storage module 110 to control the second energy storage module 120 to have a residual storage capacity so that the first energy storage module 110, particularly, the circuit structure thereof can be protected. Accordingly, the entire energy storage device 10 can be stably driven and the production cost can be reduced.

The first energy storage module 110 is formed using the unit cells of the Pb-acid battery or the NiMH battery having high stability and low cost compared to the capacity thereof, the second energy storage module 120 is formed using unit cells of the non-aqueous battery having excellent energy density and output characteristic and long life-span, and the energy storage device 10 according to the present exemplary embodiment may harmonize the merits of the two batteries.

The unit cells of the non-aqueous battery, forming the second energy storage module 120 are unit cells of the lithium ion secondary battery. A plurality of unit cells of the lithium ion battery are connected in series.

According to an exemplary embodiment, unit cells of a lithium ion battery may be combined to set a voltage of a second energy storage module to be 12V. That is, a voltage of a first energy storage module is set to 12V by connecting a plurality of unit cells of an aqueous battery in series, and the plurality of unit cells of the lithium ion battery are connected in serial to correspond to the voltage of the first energy storage module such that the voltage of the second energy storage module maybe set to 12V. According to another exemplary embodiment, a voltage of a second energy storage module may be 9.6V to 14.4V with an margin of error, that is, a voltage value corresponding to ±20% of 12V.

For example, when forming a first energy storage module of which a voltage is 12V, the voltage may be formed by connecting 6 unit cells of Pb-acid battery having a voltage of 2V in series or by connecting 10 unit cells of NiMH battery having a voltage of 1.2V in series.

When the unit cell of the lithium ion battery, that is, a non-aqueous battery is LFP/LTO, a voltage of the unit cell is 1.8V, and when the unit cell of the lithium ion battery is LFP/Graphite, the voltage thereof is 3.2V. When a lithium ion unit cell has a voltage of 1.8V, 6 of the lithium ion unit cells may be connected in series to form a second energy storage module having a voltage of 10.8V, or 7 of the lithium ion unit cells may be connected in series to form a second energy storage module having a voltage of 12.6V. Further, when a lithium ion unit cell has a voltage of 2.4V, 5 of the lithium ion unit cells may be connected in series to form a second energy storage module having a voltage of 12V, and when a lithium ion unit cell has a voltage of 3.2V, 4 of the lithium ion unit cells may be connected in series to form a second energy storage module having a voltage of 12.8V. Thus, by connecting unit cells of various lithium ion batteries, respectively formed with different positive and negative electrode active materials in series, the voltage of the second energy storage module can be maintained within a margin of error of the voltage of the first energy storage module, that is, 12V. The margin of error may be determined to be in a level that can be accepted as a voltage that is the same as a voltage of the corresponding energy storage module, but it is not limited thereto.

According to a voltage required for its usage, the second energy storage module having a voltage of the margin of error of 12V may be increased in capacity of 24V, 36V, or 448V by connected the module in plural.

A cathode active material of the lithium ion battery unit cell is LiFePO₄ (LFP) or LiMn₂O₄ (LMO). A negative active material of the lithium ion battery unit cell is graphite (Gr) or Li₄Ti₅O₁₂ (LTO). That is, the lithium ion battery unit cell may have a positive/negative electrode combination of LFP/Gr, LFP/LTO, LMO/Gr, or LMO/LTO. Preferably, a lithium ion battery unit cell of LFP/LTO and LMO/LTO may be used.

Particularly, the lithium ion battery unit cell of LFP/LTO and LMO/LTO of which a negative electrode is formed of LTO, known as the Zero-strain material so that it has excellent life-span characteristic so that the life-span of the energy storage device can be further extended compared to the life-span of an existing aqueous battery.

In the exemplary embodiment of the present invention, the cathode active material or the negative active material of the lithium ion battery unit cell is a nano-sized active material having an excellent output characteristic. That is, the lithium ion battery may be formed by forming a secondary particle core using a nano-sized primary particle of the active material. The diameter of the primary particle of the active material may be 10 nm to 2000 nm, and particularly may be 10 nm to 500 nm.

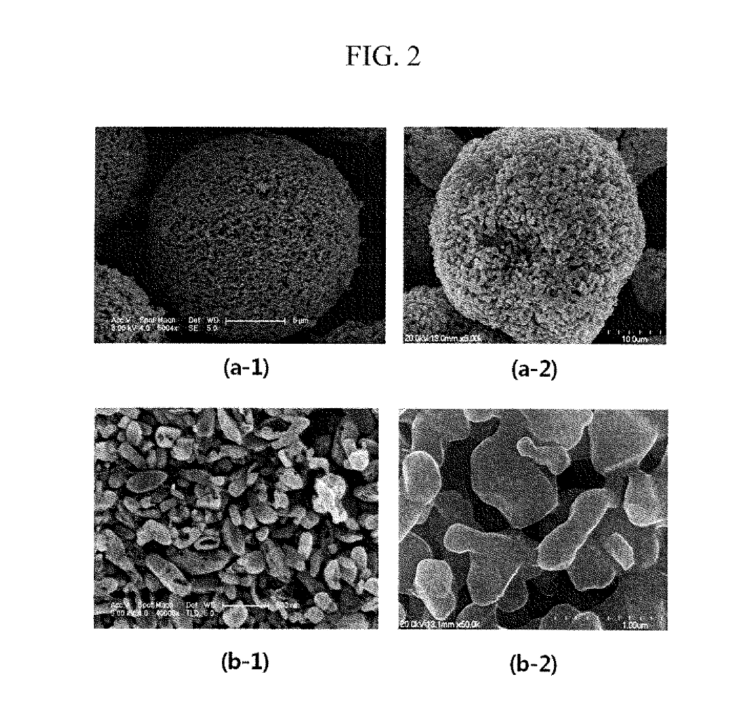

FIG. 2 illustrates a SEM (scanning electron microscope) photo of the active material of the lithium ion battery. The photo (b-1) illustrates primary particles of a nano-sized cathode active material LFP, and the photo (a-1) illustrates a secondary particle formed by condensing of primary particles. The photo (b-2) illustrates primary particles of a nano-sized negative electrode active material, and the photo (a-2) illustrates a secondary photo formed by condensing the primary particles of the negative active material LTO.

Referring again to FIG. 1, the energy storage device 10 according to the exemplary embodiment of the present invention further includes a switching unit 130 having a first switch connected to the first energy storage module 110 and a second switch connected to the second energy storage module 120. The energy storage device 10 further includes a controller 140 connected to the switching unit 130, and the controller 140 generates selection signals for controlling switching operation of each switch and transmits the selection signals to the respective switches.

Each of the selection signals transmitted to the first and second switches during a charging period are transmitted in on-voltage level corresponding to control of the controller 140 such that the corresponding switch is turned on. Thus, the first energy storage module 110 or the second energy storage module 120 connected to the switches can be selectively or simultaneously charged. Meanwhile, charged electrical energy is transmitted to the load 150 connected to the energy storage device 10 and then consumed therein. In this case, the first switch and the second switch are selectively turned on by the selection signal transmitted from the controller 140, and electrical energy stored in one of the first energy storage module 110 and the second energy storage module 120, connected to the turned-on switch is emitted.

When both of the selection signals are transmitted in on-voltage level to the first switch and the second switch, the corresponding switches are turned on and thus the first and second energy storage modules 110 and 120 can output with capacities respectively stored therein so that the energy storage device can performed charging and discharging with large capacity.

According to the exemplary embodiment of the present invention, the energy storage device 10 of FIG. 1 comprises the switching unit 130 and the controller 140 as a protection circuit system of the energy storage module. But the protection circuit system may be formed selectively, not essentially.

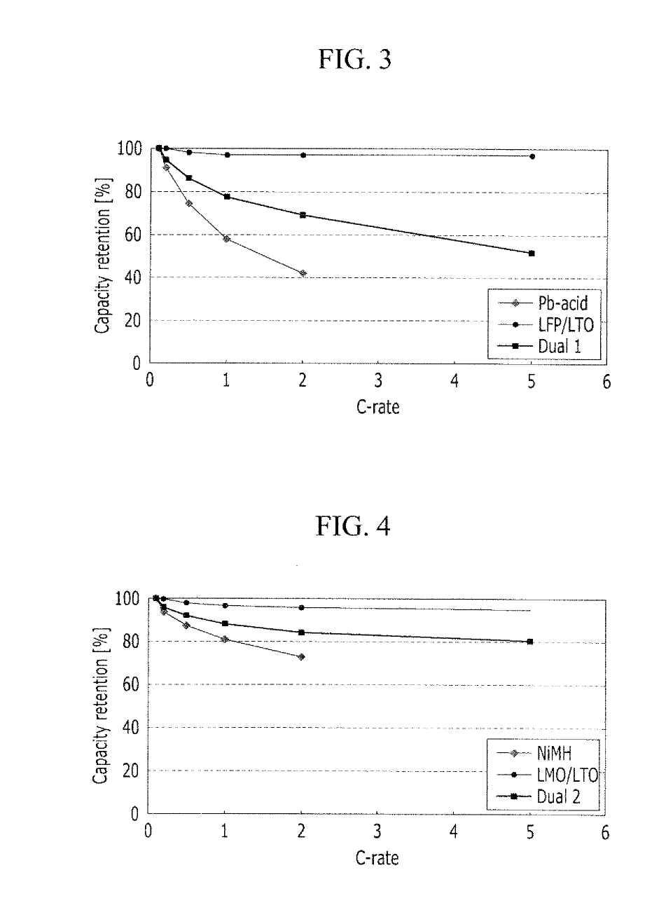

FIG. 3 and FIG. 4 are graphs illustrating capacity characteristics according to an increase of C-rate in the energy storage device according to the exemplary embodiment of the present invention. In FIG. 3 and FIG. 4, experiments of the capacity characteristics are performed while the energy storage device is not provided with the protection circuit system.

In the graphs of FIG. 3 and FIG. 4, the horizontal axis indicates C-rate and the vertical axis indicates capacity retention (%) of the energy storage device according to the present invention and a battery according to a comparative example.

Capacity retention (%)=discharge capacity at each C-rate/discharge capacity at 0.1 C-rate

The C-rate indicates a current rate as a discharge rate, and shows a discharging degree of the entire capacity of the battery. That is, 1 C-rate indicates that the entire capacity of the battery is discharged for one hour, 0.5 C indicates that the discharging is performed for 2 hours, and 2 C indicates that the discharging is performed for 30 minutes. As the C-rate is high, the output of the battery can be increased.

The energy storage device according to the exemplary of the FIG. 3 is a Dual 1 using the Pb-acid battery as the aqueous battery unit cell of the first energy storage module 110 and using LFP/LTO for the positive/negative electrode active materials as the lithium ion battery unit cell of the second energy storage module 120. In the Dual 1, the capacity of the first energy storage module 100 formed of the Pb-acid unit cells is formed to be 50% of the entire capacity and the capacity of the second energy storage module 120 is formed to be the rest 50%. As a further detailed example, the Dual 1 may be formed of a first energy storage module 110 having 6 Pb-acid unit cells connected in series and a second energy storage module 120 having 6 or 7 LFP/LTO lithium ion battery unit cells connected in series.

Capacity retentions of the Dual 1-type energy storage device of FIG. 3 were respectively measured at 0.2 C, 0.5 C, 1 C, 2 C, and 5 C for experiment of the capacity characteristic thereof.

In this case, the Dual 1 is formed by connecting the first energy storage module 110 and the second energy storage module 120 in parallel with each other, and 2.3V was used for charging and 1.6V was used for discharging in the experiment.

A comparative example shows a case of discharging only using a first exemplary storage module 110 (Pb-acid in the graph) and a case of discharging only using a second energy storage module 120 (LFP/LTO in the graph).

As shown in FIG. 3, when the experiment was performed with such a condition, the capacity retention of the first energy storage module 110 was rapidly decreased to be lower than 60% and the capacity retention of the second energy storage module 120 maintained 96% to 98% at 1 C-rate. That is, the second energy storage module 120 showed excellent characteristic.

However, the Dual 1 has the capacity retention of about a middle of the first and second energy storage modules, that is, 80% at 1 C-rate and thus the output characteristic of the Pb-acid battery has been partially improved.

As shown in FIG. 3, the first energy storage module formed of the Pb-acid unit cells has poor output characteristic, but on the contrary, the second energy storage module formed of the LFP/LTO lithium ion battery unit cell has excellent output characteristic and long life-span. The first energy storage module formed of the Pb-acid battery unit cells has merits of output stability and economical efficiency in manufacturing cost so that the Dual 1-type energy storage device formed by combing the first and second energy storage modules can maintain the output and life-span characteristics to be the middle level of those of the two batteries, thereby realizing a storage system excellent in both of economic efficiency and battery characteristic.

It can be observed that the effect of the experiment shown in FIG. 3 is the same in an experimental example shown in FIG. 4 even though the configuration thereof is changed.

That is, an energy storage device according to an exemplary embodiment of the present invention, used in the output characteristic experiment of FIG. 4 is a Dual 2-type energy storage device formed of a first energy storage module 110 formed by connecting Ni-MH unit cells in series ad a second energy storage module 120 formed by connecting LMO/LTO lithium ion battery unit cells in parallel. As a further detailed example, the Dual 2-type energy storage device may be formed of a first energy storage module 110 formed by connecting two NiMH unit cells in series and a second energy storage module 120 formed by one LMO/LTO lithium ion battery unit cell.

Capacity of the first energy storage module 110 and capacity of the second energy storage module 120 are respectively 50% of the entire capacity of the energy storage device.

As an experimental example of FIG. 4, the energy storage device was charged to 3.0V and discharged 1.8V in the experiment.

In this case, comparative examples include a case of discharging only with a first energy storage module (NiMH in the graph) formed of nickel-metal hydride battery unit cells and a case of discharging only with a second energy storage module (LMO/LTO in the graph) formed of LMO/LTO lithium ion battery unit cells.

Referring to the graph of FIG. 4, the first energy storage module (NiMH in the graph) maintained capacity of about 80% at 1 C-rate. This means that the first energy storage module of the comparative example have further excellent output and life-span characteristics compared to the first energy storage module formed of the Pb-acid battery of FIG. 3. However, the second energy storage module (LMO/LTO in the graph) was hardly discharged so that remaining capacity thereof is about 96% to 98% at 1 C-rate, and therefore the battery characteristic of the NiMH unit cell is not excellent compared to the lithium ion battery unit cell.

Since the capacity of the Dual 2-type formed by combining the nickel-metal hydride battery (NiMH) unit cell and the LMO/LTO lithium ion battery unit cell is about 90% at 1 C, the energy storage device like Dual 2-type according to the present invention can guarantee safety and economic efficiency while maintaining excellent output characteristic and life-span characteristic.

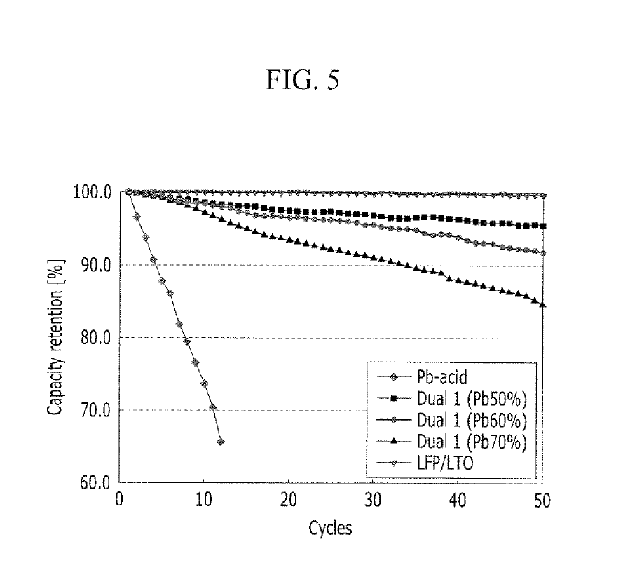

FIG. 5 is a graph illustrating a life-span characteristic that is changed according to a configuration of the aqueous battery unit cell and the non-aqueous battery unit cell in the energy storage device according to the exemplary embodiment of the present invention.

In FIG. 5, the Dual 3-type energy storage device, that is, the experimental example of FIG. 3 is used as an example for an experiment performed to observe the cycle-life characteristic. Further, comparative examples for the experiment are the same as the comparative examples of FIG. 3.

However, in the Dual 1-type according to the experimental example in FIG. 5, three experimental examples were performed with different percentages of the capacity of the Pb-acid battery unit cells of the first energy storage modules with respect to the entire energy storage capacity. That is, Dual 1 (Pb50%), Dual 1 (Pb60%), and Dual 1 (Pb70%) were respectively used.

The percentage of a lithium ion battery unit cell included in the respective experimental examples Dual 1 (Pb50%), Dual 1 (Pb60%), Dual 1 (Pb70%) are 50%, 40%, and 30% with respect to the entire energy storage capacity.

A charging/discharging voltage was charged to 2.3V and discharged to 1.6V and the experiment was performed under the 1 C-rate condition.

In the graph of FIG. 5, the horizontal axis is a discharge cycle corresponding to time and the vertical axis indicates capacity retention (%).

The comparative example (Pb-acid) performed discharging only using the first energy storage module during 10 cycles and the capacity retention was 70%. On the contrary, the comparative example (LFP/LTO) performed discharging only using the second energy storage module during 50 cycles and the capacity retention was almost 100%. That is, the capacity was hardly discharged. Thus, it can be observed that the life-span of the first energy storage module formed of the Pb-acid battery unit cells is very short but the life-span of the second energy storage module formed of the lithium ion battery unit cells is very long.

Such a short life-span characteristic of the Pb-acid battery can be improved through observation of the life-span characteristic of the duel system, that is, the energy storage device according to the present invention. As shown in FIG. 5, the capacity retention was gradually increased in the three experimental examples, Dual 1 (Pb70%), Dual 1 (Pb60%), and Dual 1 (Pb50%) during the same cycle. That is, as the capacity retention of the lithium ion battery unit cell (i.e., non-aqueous battery), that is, the capacity retention of the second energy storage module is increased, the life-span of the entire energy storage device becomes excellent. This means that the life-span of the first energy storage module formed of Pb-acid battery unit cells having short life-span characteristic is extended with help of the second energy storage module formed of LFP/LTO lithium ion battery unit cells having excellent life-span characteristic. Thus, the life-span of the storage device according to the present invention can be realized by increasing the capacity retention of the second energy storage module formed of lithium ion battery unit cells in the entire energy storage device rather than being limited to the exemplary embodiment of FIG. 5. The capacity retention of the second energy storage module with respect to the capacity of the entire energy storage device may be 10% or more, but it is not limited thereto.

In the experiments of FIG. 5, the Dual 1-type experimental example (Pb50%) has excellent life-span characteristic. That is, the entire life-span of the energy storage device of the present invention is increased as the capacity retention of the lithium ion battery unit cells is increased, but the Dual 1 type (50%) of which the capacity ratio of the Pb-acid battery unit cells and the capacity ratio of the lithium ion battery unit cells are equivalent to each other is preferably, considering the economic efficiency of the production cost of the energy storage device. Thus, the capacity ratio of the lithium ion battery unit cells may be set to be 0% to 50%.

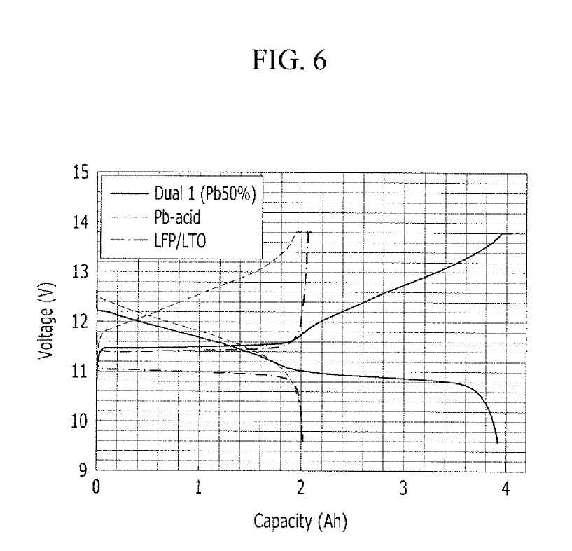

FIG. 6 is a graph illustrating a charging/discharging curved line in the case of forming a system with serial connection as the energy storage device according to the exemplary embodiment of the present invention. Charging was performed to 13.8V and discharging performed to 9.6V with 0.5 C-rate.

In FIG. 6, a charging/discharging voltage curved-line of a first energy storage module (Pb-acid in the graph) formed of Pb-acid battery unit cell is very steep, but, on the contrary, a charging/discharging voltage curved-line of a second energy storage module (LFP/LTO in the graph) has a gentle slop.

In the Dual 1-type energy storage device formed by combining two types of energy storage modules, a voltage (2.0V) of the Pb-acid battery unit cell forming the first energy storage module is higher than a voltage (1.8V) of the LFP/LTO lithium ion battery unit cell forming the second energy storage module. Thus, in the graph of FIG. 6, the LFP/LTO lithium ion battery unit cells having the low charging/discharging voltage start discharging first and then the Pb-acid battery unit cells are charged, and the Pb-acid battery unit cells having the high charging/discharging voltage are discharged first and then the LFP/LTO unit cells are discharged.

When merits of the dual system are inferred from the charging/discharging curved line of the duel system, comparing the charging/discharging characteristic, the C-rate, and the life-span result, the LFP/LTO lithium ion battery unit cells are charged first so that fast charging can be performed and the LFP/LTO lithium ion battery unit cells prevent over-discharging of the Pb-acid battery unit cells so that the life-span can be extended.

According to another exemplary embodiment of the present invention, a voltage of an aqueous battery unit cell forming a first energy storage module may be lower than a voltage of a lithium ion battery unit cell forming a second energy storage module. In this case, damage due to over-charging/discharging of the aqueous battery unit cell may be protected by a combination with a non-aqueous battery, that is, the lithium ion battery unit cell.

For safety and economic efficiency and excellent life-span characteristic of the energy storage device according to the present invention, the capacity of the unit cells of the LFP/LTO lithium ion battery having excellent life-span characteristic may be set to 50% of the entire capacity.

While this invention has been described in connection with what is presently considered to be practical exemplary embodiments, it is to be understood that the invention is not limited to the disclosed embodiments. But, on the contrary, this invention is intended to cover various modifications and equivalent arrangements included within the spirit and scope of the appended claims. Further, the materials of the components described in the specification may be selectively substituted by various known materials by those skilled in the art. In addition, some of the components described in the specification may be omitted without the deterioration of the performance or added in order to improve the performance by those skilled in the art. Moreover, the sequence of the steps of the method described in the specification may be changed depending on a process environment or equipments by those skilled in the art. Accordingly, the scope of the present invention should be determined by not the above-mentioned exemplary embodiments but the appended claims and the equivalents thereto.

What is claimed is:

1. An energy storage device comprising:
a first energy storage module formed by connecting at least one of aqueous battery unit cells in series; and
a second energy storage module formed by connecting at least one of lithium ion battery unit cells in series,
wherein the first energy storage module and the second energy storage module are connected in parallel,
the lithium ion battery unit cell is formed of a cathode active material such as LiFePO₄ (LFP) or LiMn₂O₄ (LMO), and
a voltage of the second energy storage module is included within a predetermined margin of error with reference to a voltage of the first energy storage module.

2. The energy storage device of claim 1, wherein the margin of error is 80% to 120% of the voltage of the first energy storage module.

3. The energy storage device of claim 1, wherein the voltage of the first energy storage module is 12V and the voltage of the second energy storage module is 9.6V to 14.4V.

4. The energy storage device of claim 1, wherein a negative electrode of the lithium ion battery unit cell is graphite or Li₄Ti₅O₁₂ (LTO).

5. The energy storage device of claim 1, wherein the aqueous battery unit cell is a lead-acid (Pb-acid) battery or a nickel-metal hydride (NiMH) battery.

6. The energy storage device of claim 1, wherein the second energy storage module is formed of a lithium ion battery unit cell having a voltage that is lower than a voltage of the aqueous battery unit cell.

7. The energy storage device of claim 1, wherein the second energy storage module is formed of a lithium ion battery unit cell having a voltage that is higher than a voltage of the aqueous battery unit cell.

8. The energy storage device of claim 1, wherein a voltage of the aqueous battery unit cell is 1.0V to 2.5V and a voltage of the lithium ion battery unit cell is 1.5V to 3.5V.

9. The energy storage device of claim 1, wherein the aqueous battery unit cell is a Pb-acid battery and the lithium ion battery unit cell is LiFePO₄/Li₄Ti₅O₁₂ (LFP/LTO).

10. The energy storage device of claim 1, wherein a storage capacity of the first energy storage module is more than 50% to less than 100% of a total storage capacity of the energy storage device.

11. The energy storage device of claim 1, wherein a storage capacity of the second energy storage module is more than 10% to less than 50% of a total storage capacity of the energy storage device.

12. The energy storage device of claim 1, wherein the energy storage device further comprises:
a switching unit including at least one switch connected to the first energy storage module or the second energy storage module; and
a controller generating a selection signal for controlling switching operation of the switch and selecting the first energy storage module or the second energy storage module.

13. The energy storage device of claim 1, wherein a cathode active material and a negative active material of the lithium ion battery unit cell have nano miter-sized primary particles.

14. The energy storage device of claim 13, wherein the diameter of the primary particle is 10 nm to 2000 nm.

15. The energy storage device of claim 1, wherein a combination of the aqueous battery unit cell-the lithium ion battery unit cell forming the energy storage device is selected from combinations of Pb-acid-LFP/LTO, Pb-acid-LMO/LTO, Pb-acid-LFP/Graphite, Pb-acid-LMO/Graphite, and NiMH-LMO/LTO.
